(19) United States
(12) Patent Application Publication
(10) Pub. No.: US 2026/0046519 A1
(43) Pub. Date: Feb. 12, 2026

(54) Systems and Methods for Phase Detection Autofocus Enhancement based on Motion-Blur Resistant Frame Stacking Focus Disparity Determination

(71) Applicant: Google LLC, Mountain View, CA (US)

(72) Inventors: Maximilian Michael Janke, Taipei City (TW); Sung Hyun Hwang, Sunnyvale, CA (US); Leung Chun Chan, Sunnyvale, CA (US); Hsuan Ming Liu, Taipei (TW); TunChieh Chang, Taipei (TW)

(21) Appl. No.: 19/296,269

(22) Filed: Aug. 11, 2025

Related U.S. Application Data
(60) Provisional application No. 63/682,033, filed on Aug. 12, 2024.

(51) Int. Cl. H04N 23/67; H04N 23/68; H04N 23/71

(52) U.S. Cl. CPC H04N 23/672; H04N 23/6811; H04N 23/687; H04N 23/71

(57) ABSTRACT

An example method includes receiving a plurality of successive sets of phase-detection (PD) image frames. The method also includes determining, for each set of the plurality of successive sets, a respective similarity measure indicative of a respective frame disparity in the PD image frames. The method additionally includes determining an aggregated similarity measure by aggregating respective similarity measures corresponding to the plurality of successive sets. The method further includes predicting, based on the aggregated similarity measure, a focus disparity for phase-detection autofocus (PDAF). The method also includes providing, based on the predicted focus disparity, an adjustment to a lens position for a camera.

### CROSS REFERENCE TO RELATED APPLICATIONS

This application claims priority to U.S. Provisional Patent Application No. 63/682,033, filed Aug. 12, 2024, the contents of which are incorporated herein by reference in their entirety.

### BACKGROUND

Many modern computing devices, including mobile phones, personal computers, and tablets, include image capture devices, such as still and/or video cameras. The image capture devices can capture images, such as images that include people, animals, landscapes, and/or objects. Such objects may appear at different depths in the image.

### SUMMARY

This application generally relates to improving phase-detection autofocus (PDAF) performance. In particular, the application relates to improving the PDAF performance (e.g., in low-light conditions) under streaming inputs, without the need for long exposure times and/or additional computational overhead. Existing approaches to enhancing stability and low light performance involves (1) applying a temporal filter to gain the right stability (sometimes at the cost of accuracy); (2) stack up raw image data from different frames to improve accuracy and stability (at the cost of motion blur artifacts); and (3) glue raw images to generate a larger image.

In some approaches, PDAF performance may be improved by collecting more information in a pre-pipeline (for image processing). This may be achieved by increasing exposure time and temporally stacking raw image data from multiple frames. Such an approach has the advantage that there is no information loss and the result is more accurate. However, in the event the scene involves motion (e.g., movement of a subject in the scene, or a panning of the camera), the PDAF performance may be negatively impacted due to oversaturation, light leaks, and/or camera shaking. Also, for example, stacking raw image frames is likely to result in motion blur.

The techniques described herein can improve PDAF performance, especially in low-light conditions, or for applications involving a temporal post-pipeline filter under streaming inputs. As described herein, multiple image frames are taken together and a stacked result is generated by performing a rolling sum over intermediate information (e.g., in a block matching algorithm (BMA) pipeline). The stacked result enhances autofocus capabilities significantly, without the need for long exposure times or additional computational overhead. The PDAF outcome becomes more stable and can be used in lowlight conditions without being impacted by motion blur.

In one aspect, a computer-implemented method is provided. The method includes receiving a plurality of successive sets of phase-detection (PD) image frames. The method also includes determining, for each set of the plurality of successive sets, a respective similarity measure indicative of a respective frame disparity in the PD image frames. The method additionally includes determining an aggregated similarity measure by aggregating respective similarity measures corresponding to the plurality of successive sets. The method further includes predicting, based on the aggregated similarity measure, a focus disparity for phase-detection autofocus (PDAF). The method also includes providing, based on the predicted focus disparity, an adjustment to a lens position for a camera.

In another aspect, a system is provided. The system may include one or more processors. The system may also include data storage, where the data storage has stored thereon computer-executable instructions that, when executed by the one or more processors, cause the system to carry out operations. The operations may include receiving a plurality of successive sets of phase-detection (PD) image frames. The operations may also include determining, for each set of the plurality of successive sets, a respective similarity measure indicative of a respective frame disparity in the PD image frames. The operations may additionally include determining an aggregated similarity measure by aggregating respective similarity measures corresponding to the plurality of successive sets. The operations may further include predicting, based on the aggregated similarity measure, a focus disparity for phase-detection autofocus (PDAF). The operations may also include providing, based on the predicted focus disparity, an adjustment to a lens position for a camera.

In another aspect, a computing device is provided. The device may include one or more processors. The device may also include data storage, where the data storage has stored thereon computer-executable instructions that, when executed by the one or more processors, cause the device to carry out operations. The operations may include receiving a plurality of successive sets of phase-detection (PD) image frames. The operations may also include determining, for each set of the plurality of successive sets, a respective similarity measure indicative of a respective frame disparity in the PD image frames. The operations may additionally include determining an aggregated similarity measure by aggregating respective similarity measures corresponding to the plurality of successive sets. The operations may further include predicting, based on the aggregated similarity measure, a focus disparity for phase-detection autofocus (PDAF). The operations may also include providing, based on the predicted focus disparity, an adjustment to a lens position for a camera.

In another aspect, an article of manufacture is provided. The article of manufacture may include a non-transitory computer-readable medium having stored thereon program instructions that, upon execution by one or more processors of a computing device, cause the computing device to carry out operations. The operations may include receiving a plurality of successive sets of phase-detection (PD) image frames. The operations may also include determining, for each set of the plurality of successive sets, a respective similarity measure indicative of a respective frame disparity in the PD image frames. The operations may additionally include determining an aggregated similarity measure by aggregating respective similarity measures corresponding to the plurality of successive sets. The operations may further include predicting, based on the aggregated similarity measure, a focus disparity for phase-detection autofocus (PDAF). The operations may also include providing, based on the predicted focus disparity, an adjustment to a lens position for a camera.

In another aspect, a program is provided. The program, upon execution by one or more processors of a computing device, causes the computing device to carry out operations. The operations may include receiving a plurality of successive sets of phase-detection (PD) image frames. The operations may also include determining, for each set of the plurality of successive sets, a respective similarity measure indicative of a respective frame disparity in the PD image frames. The operations may additionally include determining an aggregated similarity measure by aggregating respective similarity measures corresponding to the plurality of successive sets. The operations may further include predicting, based on the aggregated similarity measure, a focus disparity for phase-detection autofocus (PDAF). The operations may also include providing, based on the predicted focus disparity, an adjustment to a lens position for a camera.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 is an illustration of front, right-side, and rear views of a digital camera device, in accordance with example embodiments.

FIG. 2 is an example graphical representation of similarity, in accordance with example embodiments.

FIG. 3A is an example illustration of post-pipeline image processing, in accordance with example embodiments.

FIG. 3B is an example illustration of pre-pipeline image processing, in accordance with example embodiments.

FIG. 4 is an example graphical representation of stabilizing the auto-focus feature, in accordance with example embodiments.

FIG. 5 is an example overview of a phase-detection autofocus (PDAF) pipeline, in accordance with example embodiments.

FIG. 6 is an example illustration of raw images in the PDAF pipeline, in accordance with example embodiments.

FIG. 7A is an example illustration of determining zero-normalized cross-correlation (ZNCC) values, in accordance with example embodiments.

FIG. 7B is an example graphical illustration of a zero-normalized cross-correlation (ZNCC) curve, in accordance with example embodiments.

FIG. 8 is an example graphical illustration of determining disparity in the PDAF pipeline, in accordance with example embodiments.

FIG. 9 illustrates determination of peak similarity and curvature in the PDAF pipeline, in accordance with example embodiments.

FIG. 10 is an example illustration of camera calibration in the PDAF pipeline, in accordance with example embodiments.

FIG. 11 illustrates a high energy image and a low energy image, in accordance with example embodiments.

FIG. 12 is a block diagram of an example computing device, in accordance with example embodiments.

FIG. 13 is a flowchart of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### Overview

Focus stack fusion may take two or more images as input, and combine them to generate a single “denoised” image, and use the denoised image to achieve enhanced focus results. For example, focus stack fusion may stack images of same or similar focal distances.

Existing approaches involving post-pipeline solutions for improving PDAF performance include smoothing, averaging and/or filtering pd-results. These approaches generally do not primarily target accuracy, having better focus results, and instead attempt to improve stability of the image. Stability is an important factor for general user experience that may be traded-off for some accuracy. For example, in the event the focus is close to accurate, unstable lens movement may be perceptible to the user and may be quite undesirable. In the event the focus is completely inaccurate and the image is blurry, then this is certainly perceptible to the user. However, once inaccuracy increases, it is challenging to achieve a desirable focus result, and the smoothing approach ceases to be beneficial.

The techniques described herein combine the afore-mentioned three approaches into one by using a stacking module that sums up information (temporal, and/or spatio-temporal) from multiple image frames captured over time. For example, information may be summed up spatio-temporally for a scene with a running horse (at approximately the same depth in different image frames). As another example, a scene with minimal movement may be summed up temporally. Similarity curves corresponding to different frames may be stacked together by aggregating constituent terms for similarity measures. For example, constituent terms may be aggregated for a sum of absolute differences (SAD) of the frames, and for a sum of squared differences (SSD) of the frames. Generally, the lower the SAD or SSD, the more the frames are correlated. Also, for example, constituent terms may be aggregated by summing up multiple (e.g. six) constituent terms, such as for advanced similarity measures such as zero-normalized cross-correlation (ZNCC). Generally, the higher the ZNCC, the more the frames are correlated. Although similarity curves for individual frames may display a large variation in a defocus range and/or a large variation in a confidence level, the stacking of the similarity curves results in a smaller variation in a defocus range and/or a smaller variation in a confidence level.

Various techniques may be used to generate depth information for an image. In some cases, depth information may be generated for the entire image (e.g., for the entire image frame). In other cases, depth information may only be generated for a certain area or areas in an image. For instance, depth information may only be generated when image segmentation is used to identify one or more objects in an image. Depth information may be determined specifically for the identified object or objects.

Accordingly, a disparity value for lens correction may be determined from the stacked similarity curve, resulting in improved PDAF performance. In some embodiments, the stacked similarity curve may be used to determine a peak similarity value and a curvature. The peak similarity value and the curvature may be used as confidence measures for the disparity value. For example, the disparity value may be determined to be of high confidence when the peak similarity value is within a peak threshold, and the curvature is within a curvature threshold. In some embodiments, the constituent measures may be used as a confidence measure. For example, the denominator of the ZNCC (also referred to as the energy) may be used as a confidence measure.

Camera behavior on motion scenes (e.g., where the motion is away from the camera) may be compared to the behavior on multiple-depth scenes. Based on the techniques described herein, the behavior on several frames of different depths is likely to resemble the result on one frame, which combines the different depths. Although classical filters may sometimes be applied, differences in exposure and texture in the different frames is unlikely to be resolved using the classical filters. For example, a filter generally does not pick up on such differences (some advanced filters that take confidence into account may pick up some differences, but would be perceptibly different from what this technology achieves). In some embodiments, use of the techniques described herein is likely to add, to a computer code, permanent state variables that could resemble a ‘queue/ring-buffer/list’.

### Example Camera Systems

As image capture devices, such as cameras, become more popular, they may be employed as standalone hardware devices or integrated into various other types of devices. For instance, still and video cameras are now regularly included in wireless computing devices (e.g., mobile devices, such as mobile phones), tablet computers, laptop computers, video game interfaces, home automation devices, and even automobiles and other types of vehicles.

The physical components of a camera may include one or more apertures through which light enters, one or more recording surfaces for capturing the images represented by the light, and lenses positioned in front of each aperture to focus at least part of the image on the recording surface(s). The apertures may be of a fixed size or may be adjustable. In an analog camera, the recording surface may be a photographic film. In a digital camera, the recording surface may include an electronic image sensor (e.g., a charge coupled device (CCD) or a complementary metal-oxide-semiconductor (CMOS) sensor) to transfer and/or store captured images in a data storage unit (e.g., memory).

One or more shutters may be coupled to, or positioned near, the lenses or the recording surfaces. Each shutter may either be in a closed position, in which it blocks light from reaching the recording surface, or an open position, in which light is allowed to reach the recording surface. The position of each shutter may be controlled by a shutter button. For instance, a shutter may be in the closed position by default. When the shutter button is triggered (e.g., pressed), the shutter may change from the closed position to the open position for a period of time, known as the shutter cycle. During the shutter cycle, an image may be captured on the recording surface. At the end of the shutter cycle, the shutter may change back to the closed position.

Alternatively, the shuttering process may be electronic. For example, before an electronic shutter of a CCD image sensor is “opened,” the sensor may be reset to remove any residual signal in its photodiodes. While the electronic shutter remains open, the photodiodes may accumulate charge. When or after the shutter closes, these charges may be transferred to longer-term data storage. Combinations of mechanical and electronic shuttering may also be possible.

Regardless of type, a shutter may be activated and/or controlled by something other than a shutter button. For instance, the shutter may be activated by a softkey, a timer, or some other trigger. Herein, the term “capture” may refer to any mechanical and/or electronic shuttering process that results in one or more images being recorded, regardless of how the shuttering process is triggered or controlled.

The exposure of a captured image may be determined by a combination of the size of the aperture, the brightness of the light entering the aperture, and the length of the shutter cycle (also referred to as the shutter length, the exposure length, or the exposure time). Additionally, a digital and/or analog gain (e.g., based on an ISO setting) may be applied to the image, thereby influencing the exposure. In some embodiments, the term “exposure length,” “exposure time,” or “exposure time interval” may refer to the shutter length multiplied by the gain for a particular aperture size. Thus, these terms may be used somewhat interchangeably, and should be interpreted as possibly being a shutter length, an exposure time, and/or any other metric that controls the amount of signal response that results from light reaching the recording surface.

In some implementations or modes of operation, a camera may capture one or more still images each time image capture is triggered. In other implementations or modes of operation, a camera may capture a video image by continuously capturing images at a particular rate (e.g., 24 frames per second) as long as image capture remains triggered (e.g., while the shutter button is held down). Some cameras, when operating in a mode to capture a still image, may open the shutter when the camera device or application is activated, and the shutter may remain in this position until the camera device or application is deactivated. While the shutter is open, the camera device or application may capture and display a representation of a scene on a viewfinder (sometimes referred to as displaying a “preview frame”). When image capture is triggered, one or more distinct payload images of the current scene may be captured.

Cameras, including digital and analog cameras, may include software to control one or more camera functions and/or settings, such as aperture size, exposure time, gain, and so on. Additionally, some cameras may include software that digitally processes images during or after image capture. While the description above refers to cameras in general, it may be particularly relevant to digital cameras. Digital cameras may be standalone devices (e.g., a DSLR camera) or may be integrated with other devices.

Either or both of a front-facing camera and a rear-facing camera may include or be associated with an ALS that may continuously or from time to time determine the ambient brightness of a scene that the camera can capture. In some devices, the ALS can be used to adjust the display brightness of a screen associated with the camera (e.g., a viewfinder). When the determined ambient brightness is high, the brightness level of the screen may be increased to make the screen easier to view. When the determined ambient brightness is low, the brightness level of the screen may be decreased, also to make the screen easier to view as well as to potentially save power. Additionally, the ambient light sensor's input may be used to determine an exposure time of an associated camera, or to help in this determination.

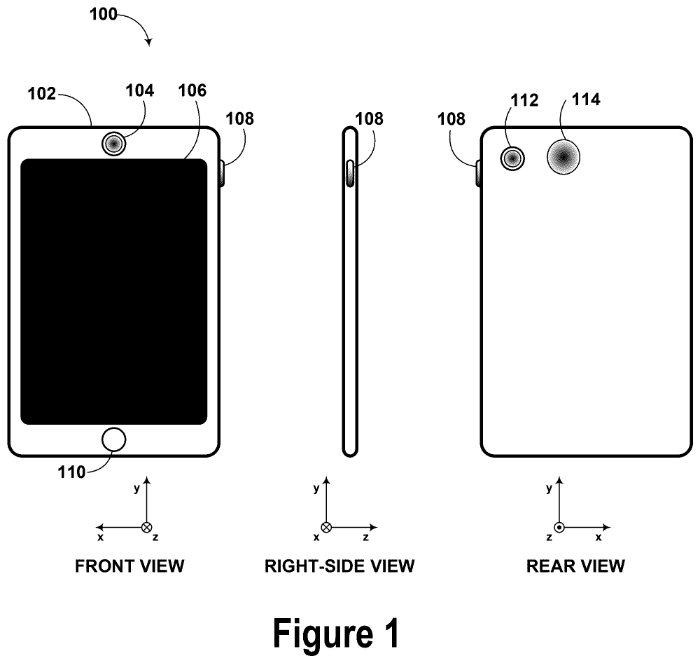

FIG. 1 is an illustration of front, right-side, and rear views of a digital camera device 100, in accordance with example embodiments. Digital camera device 100 may be, for example, a mobile device (e.g., a mobile phone), a tablet computer, or a wearable computing device. However, other embodiments are possible. Digital camera device 100 may include various elements, such as a body 102, a front-facing camera 104, a multi-element display 106, a shutter button 108, and other buttons 110. Digital camera device 100 could further include one or more rear-facing cameras 112, 114. Front-facing camera 104 may be positioned on a side of body 102 typically facing a user while in operation, or on the same side as multi-element display 106. Rear-facing cameras 112, 114 may be positioned on a side of body 102 opposite front-facing camera 104. Referring to the cameras as front-facing and rear-facing is arbitrary, and digital camera device 100 may include multiple cameras positioned on various sides of body 102.

Multi-element display 106 could represent a cathode ray tube (CRT) display, a light-emitting diode (LED) display, a liquid crystal display (LCD), a plasma display, or any other type of display known in the art. In some embodiments, multi-element display 106 may display a digital representation of the current image being captured by front-facing camera 104 and/or rear-facing cameras 112, 114, or an image that could be captured or was recently captured by either or both of these cameras. Thus, multi-element display 106 may serve as a viewfinder for either camera. Multi-element display 106 may also support touchscreen and/or presence-sensitive functions that may be able to adjust the settings and/or configuration of any aspect of digital camera device 100.

Multi-element display 106 may include additional features related to a camera application. For example, multiple modes may be available for a user, including, a motion mode, portrait mode, video mode, video bokeh mode, and so forth. The camera application may be in camera mode and provide additional features, such as a reverse icon to activate reverse camera view, a trigger button to capture a previewed image, and a photo stream icon to access a database of captured images. Also for example, a magnification ratio slider may be displayed and a user can move a virtual object along the magnification ratio slider to select a magnification ratio. In some embodiments, a user may use the multi-element display 106, also referred to herein as the display screen, to adjust the magnification ratio (e.g., by moving two fingers on display screen in an outward motion away from each other), and magnification ratio slider may automatically display the magnification ratio.

Front-facing camera 104 may include an image sensor and associated optical elements such as lenses. Front-facing camera 104 may offer zoom capabilities or could have a fixed focal length. In other embodiments, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent a monoscopic, stereoscopic, or multiscopic camera. Rear-facing cameras 112, 114 may be similarly or differently arranged. Additionally, front-facing camera 104, rear-facing cameras 112, 114, or both, may be an array of one or more cameras.

Either or both of front-facing camera 104 and rear-facing cameras 112, 114 may include or be associated with an illumination component that provides a light field to illuminate a target object. For instance, an illumination component could provide flash or constant illumination of the target object (e.g., using one or more LEDs). An illumination component could also be configured to provide a light field that includes one or more of structured light, polarized light, and light with specific spectral content. Other types of light fields known and used to recover three-dimensional (3D) models from an object are possible within the context of the embodiments herein.

In some digital camera devices 100, either or both of front-facing camera 104 and rear-facing cameras 112, 114 may include or be associated with an ambient light sensor that may continuously or from time to time determine the ambient brightness of a scene that the camera can capture. In some devices, the ambient light sensor can be used to adjust the display brightness of a screen associated with the camera (e.g., a viewfinder). When the determined ambient brightness is high, the brightness level of the screen may be increased to make the screen easier to view. When the determined ambient brightness is low, the brightness level of the screen may be decreased, also to make the screen easier to view as well as to potentially save power. Additionally, the ambient light sensor's input may be used to determine an exposure time of an associated camera, or to help in this determination.

Digital camera device 100 could be configured to use multi-element display 106 and either front-facing camera 104 or rear-facing cameras 112, 114 to capture images of a target object (e.g., a subject within a scene). The captured images could be a plurality of still images or a video image (e.g., a series of still images captured in rapid succession with or without accompanying audio captured by a microphone). The image capture could be triggered by activating shutter button 108, pressing a softkey on multi-element display 106, or by some other mechanism. Depending upon the implementation, the images could be captured automatically at a specific time interval, for example, upon pressing shutter button 108, upon appropriate lighting conditions of the target object, upon moving digital camera device 100 a predetermined distance, or according to a predetermined capture schedule.

As noted above, the functions of digital camera device 100 (or another type of digital camera) may be integrated into a computing device, such as a wireless computing device, cell phone, tablet computer, laptop computer, and so on. For example, a camera controller may be integrated with the digital camera device 100 to control one or more functions of the digital camera device 100.

### Example Phase-Detection Autofocus (PDAF) Pipelines

One approach to improving PDAF is to improve the signal-to-noise ratio (SNR). This can be achieved by using better algorithms to reduce noise, and/or by improving the signal quality. The signal quality may be improved by enlarging a region of interest or by using a high quality image sensor. However, such approaches can be expensive as well as resource intensive. The signal can also be particularly unstable in low light situations, even in the presence of multiple frames. Accordingly, for a given automatic exposure (AE) setting as adjusted by an AE controller, the auto focus (AF) logic may involve stacking the frames (e.g., by aggregating similarity measures) over time to improve signal quality.

The SNR may pose challenges to the performance of the autofocus algorithm. For example, although algorithm optimization may enhance results, the optimization cannot inherently overcome the SNR barrier. However, stacking offers a unique solution by leveraging information from multiple frames. This approach effectively amplifies the signal strength proportionally to the number of frames used, making it easier to distinguish from noise and thus enhancing autofocus accuracy. Importantly, this contrasts with typical algorithm improvements, which often focus on optimizing existing data rather than increasing signal strength.

Generally, in order to enhance PDAF, the algorithm may be improved, or the signal may be increased. Algorithmic improvements are constrained by the SNR, and while hardware enhancements can boost SNR, such improvements are associated with increased cost. Software solutions can increase the signal in two ways: spatially and temporally. The former may not be practical. The region of interest cannot be made larger as it is likely as big as the object of focus. Temporal enhancement is so far largely untapped (except for temporal filters). Stacking is an approach that leverages the temporal dimension by combining data from multiple frames, improving the signal and ultimately PDAF performance.

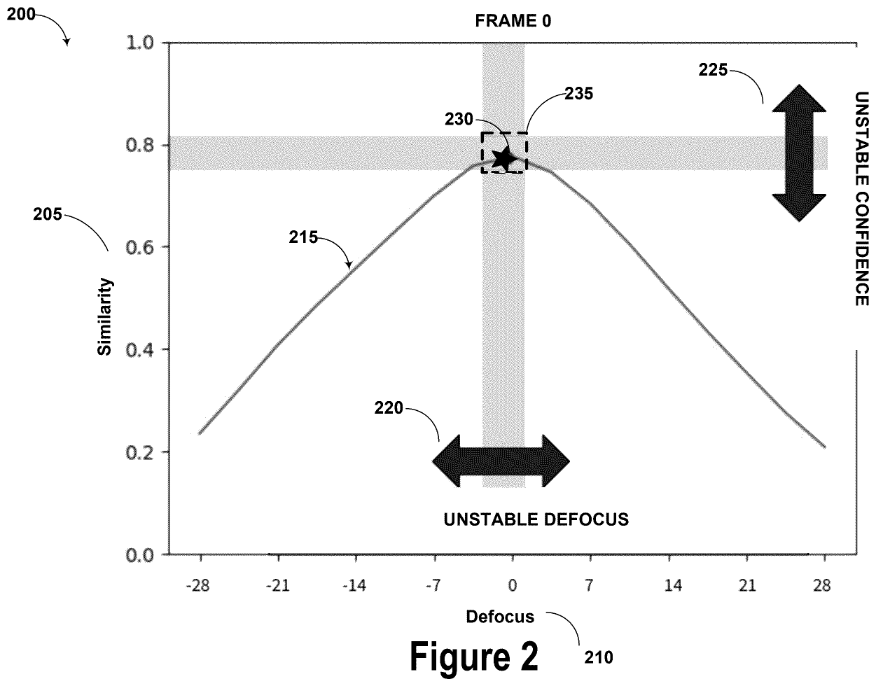

FIG. 2 is an example graphical representation 200 of similarity, in accordance with example embodiments. Similarity values 205 are indicated along a vertical axis and defocus values 210 are indicated along a horizontal axis. A similarity curve 215 corresponding to frame 0 is shown. As successive frames are captured, the respective peak points of the corresponding similarity curves, like peak point 230 of similarity curve 215, are likely to be positioned at various locations within box 235. Box 235 corresponds to a relatively large horizontal range 220 of defocus values and a relatively large vertical range 225 of confidence values. This can result in an unstable defocus.

Performing PDAF may be challenging for camera systems, for example, in some extreme lowlight conditions. A fewer number of captured photons may limit available information, and accurate focus acquisition may be impeded. One approach to solving this problem is to stack the intermediate processing outputs of the PDAF pipeline, specifically similarity curves. This combines advantages of temporally stacking PD raw images (or increasing exposure time) before the pipeline, and advantages of temporally smoothing PDAF-results post pipeline.

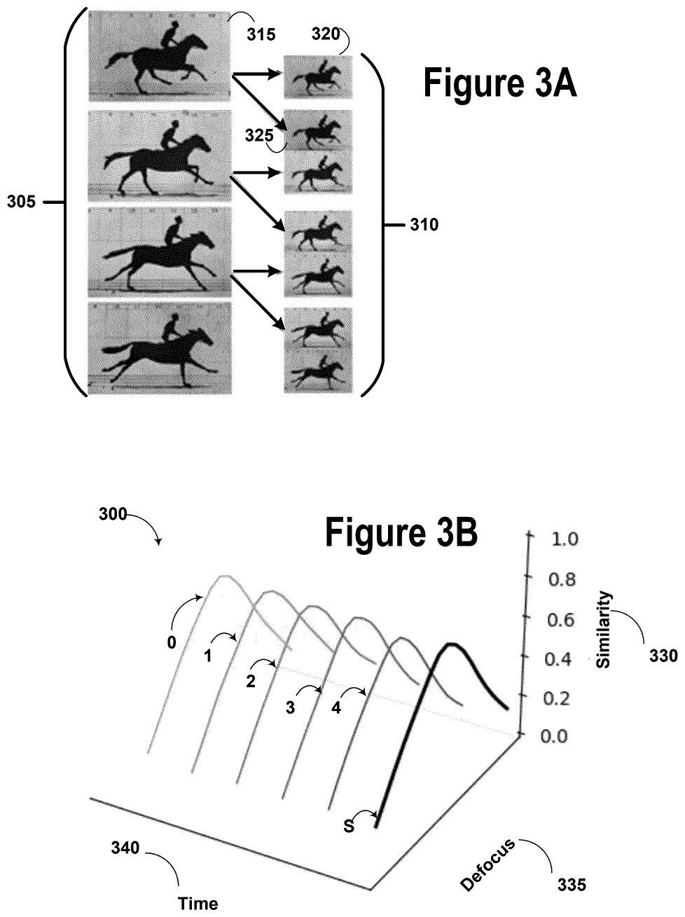

FIG. 3A is an example illustration of post-pipeline image processing, in accordance with example embodiments. Images 305 represent frames displaying motion (e.g., movements of a horse). Images 310 correspond to a plurality of successive sets of PD image frames, each pair comprising a perspective of a scene from a different part of a lens. For example, image 315 corresponds to a frame of an image with a horse, a first image of the scene from the first portion of the lens is depicted in image 320, and a second image of the scene from the second portion of the lens is depicted in image 325.

Generally, when image frames with motion are stacked together during post-pipeline image processing, as illustrated in FIG. 3A, motion blur artifacts are introduced as a result of the stacking. However, the pre-pipeline image processing described in FIG. 3B eliminates and/or reduces such motion blur artifacts.

FIG. 3B is an example illustration of pre-pipeline image processing 300, in accordance with example embodiments. FIG. 3B illustrates five (5) similarity curves labeled “0” to “4” corresponding to frames “0” to “4.” For example, similarity curve 0 may correspond to similarity curve 215 of FIG. 2. In FIG. 3B, the vertical axis represents similarity values 330, the horizontal axis represents defocus values 335 and a third temporal axis represents time 340. In some embodiments, an aggregated similarity curve labeled “S” may be determined by aggregating respective similarity measures “0,” “1,” “2,” “3,” and “4.”

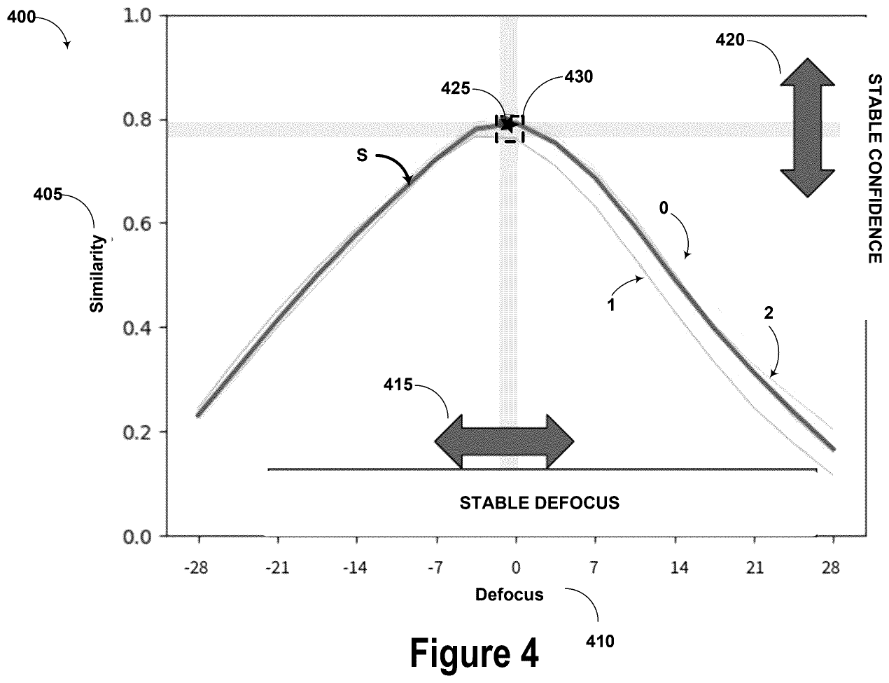

FIG. 4 is an example graphical representation 400 of stabilizing the auto-focus feature, in accordance with example embodiments. Similarity values 405 are indicated along a vertical axis and defocus values 410 are indicated along a horizontal axis. Similarity curves labeled “0” to “2” corresponding to frames “0” to “2” are displayed. For example, the similarity curves labeled “0” to “2” may correspond to some of the similarity curves labeled “0” to “4” of FIG. 3A (with the time axis collapsed and the curves superimposed onto each other). As illustrated in FIG. 2, as successive frames are captured, the respective peak points of the corresponding similarity curves, like peak point 230 of similarity curve 215 of FIG. 2, arc likely to be positioned at various locations within box 235 of FIG. 2. Box 235 corresponds to a relatively large horizontal range 220 of defocus values and a relatively large vertical range 225 of confidence values. This can result in an unstable defocus. However, as illustrated in FIG. 4, the successive similarity curves may be aggregated to obtain an aggregated similarity curve labeled “S.” An aggregated peak point 425 of aggregated similarity curve “S” is generally located within box 430. The aggregated peak point 425 indicates an amount of lens adjustment to be applied for defocus. Box 430 corresponds to a relatively smaller horizontal range 415 of defocus values and a relatively smaller vertical range 420 of confidence values. This results in a stable defocus and a stable confidence level.

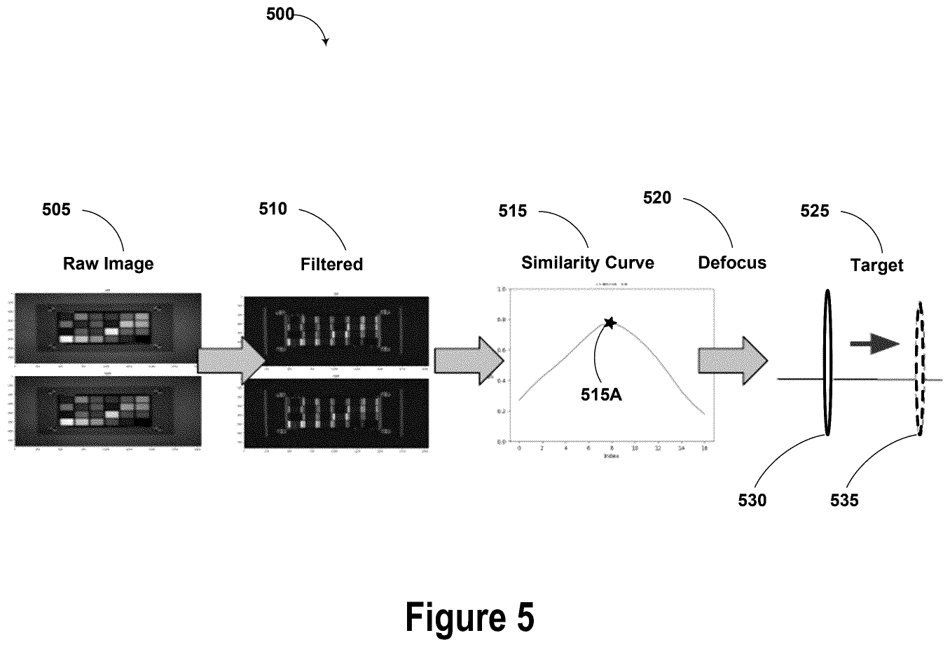

FIG. 5 is an example overview of a phase-detection autofocus (PDAF) pipeline 500, in accordance with example embodiments. Some embodiments involve receiving a plurality of successive sets of phase-detection (PD) image frames. The term “set of PD image frames” can refer to a pair of images with the same perspective but captured by different parts of a camera lens. In some embodiments, the term “set of PD image frames” can refer to a stereo pair that includes a left image of a scene and a right image of the scene. For example, a block matching algorithm (BMA) may be applied to the stereo images. In some embodiments, the term “set of PD image frames” can refer to a PD image tuple (e.g., a quadlet corresponding to Quad pixels). Additional, and//or alternative types of sets of PD image frames may be used.

For example, raw image 505 may represent a pair of images with the same perspective but captured by different parts of a camera lens. Filter 510 is applied to provide a better contrast for the shift between the left and right images. Some embodiments involve determining, for each set of the plurality of successive sets, a respective similarity measure indicative of a respective frame disparity in the PD image frames. Generally, a frame may include different disparities in different regions. The term “disparity” as used herein generally refers to a focus disparity of an object of interest or a region of interest in a set of PD image frames. The term “similarity measure” as used herein generally refers to any measure indicative of a degree of similarity between two images. In some embodiments, the similarity measure may be indicative of a shift between the image frames in a set of PD image frames (e.g., a shift between a left and a right image in a stereo pair).

As illustrated in FIG. 5, a similarity curve 515 is determined. The peak point 515A indicates an amount of lens adjustment to be applied for defocus 520. Defocus 520 includes an initial lens position 530 and a target lens position 535.

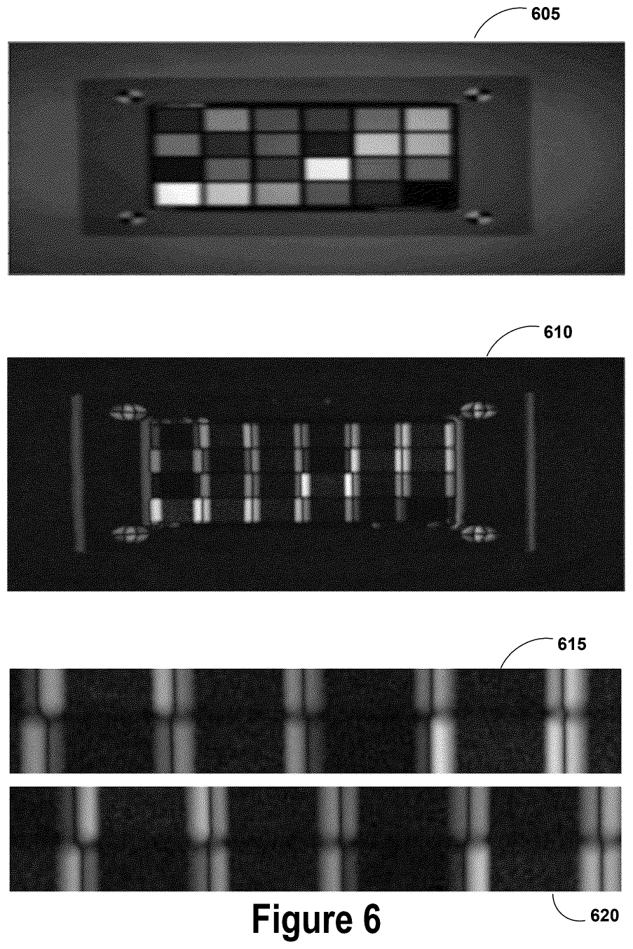

FIG. 6 is an example illustration of raw images in the PDAF pipeline, in accordance with example embodiments. For example, raw image 605 is displayed. Image 610 is a filtered raw image. Image 615 and image 620 are filtered raw images corresponding to left and right images, indicating a shift (e.g., focus disparity).

Some embodiments involve determining an aggregated similarity measure by aggregating respective similarity measures corresponding to the plurality of successive sets. The term “aggregated similarity measure” as used herein generally refers to combining similarity measures that are indicative of respective frame disparities in a set of PD image frames. There may be several ways to combine the similarity measures. Generally, this may involve summing a few discrete components of the similarity measures. Such a sum is not computationally resource intensive.

For purposes of stacking, a normalized cross-correlation (NCC) may be determined as:

$$NCC = \frac{〈 L , R 〉}{\sqrt{〈 L , L 〉 〈 R , R 〉}} \qquad ( Eqn . 1 )$$

where L and R denote the left and right images respectively and <, > denotes the Frobenius product. Scalar products other than the Frobenius product may also be used. Such a formulation is valid in the presence of a (canonical) inner product between the left and right images. For example, subregions of the sets of PD image frames (i.e. (shifted) regions of interest (ROIs)) may be used. Also, for example, temporal data may be applied, that transforms L and R into three-dimensional tensors. The three constituents of the NCC in Eqn. 1 may be referred to as a numerator <L, R>, a left denominator <L, L> and a right denominator <R, R>. Generally, these terms commute with (direct) sums. For example, the numerator of several frames is a sum of numerators of each individual frame. Similar considerations apply to the denominators. This may be generally referred to as a stacking property.

In some embodiments, the determining of the aggregated similarity measure includes aggregating constituent terms for a zero-normalized cross-correlation (ZNCC) of the image frames in a set of PD image frames. One formulation of the ZNCC may be a NCC of normalized images, where an average pixel value may be subtracted from each image. This extra step does not impact an ability to stack images, as long as each frame is assumed to be associated with a respective zero-normalization. In this case, the stacked ZNCC is substantially similar to the ZNCC of the individual images glued together.

Another formulation of the ZNCC may be based on a linearity property of the scalar product and rearranging terms. This is an efficient way to compute the ZNCC and also has the stacking property. Constituents of the formulation may be aggregated to obtain the ZNCC of several frames. For example, the ZNCC may be computed based on six (6) constituent terms. In this case, the stacked ZNCC is the same as the ZNCC of the individual images glued together.

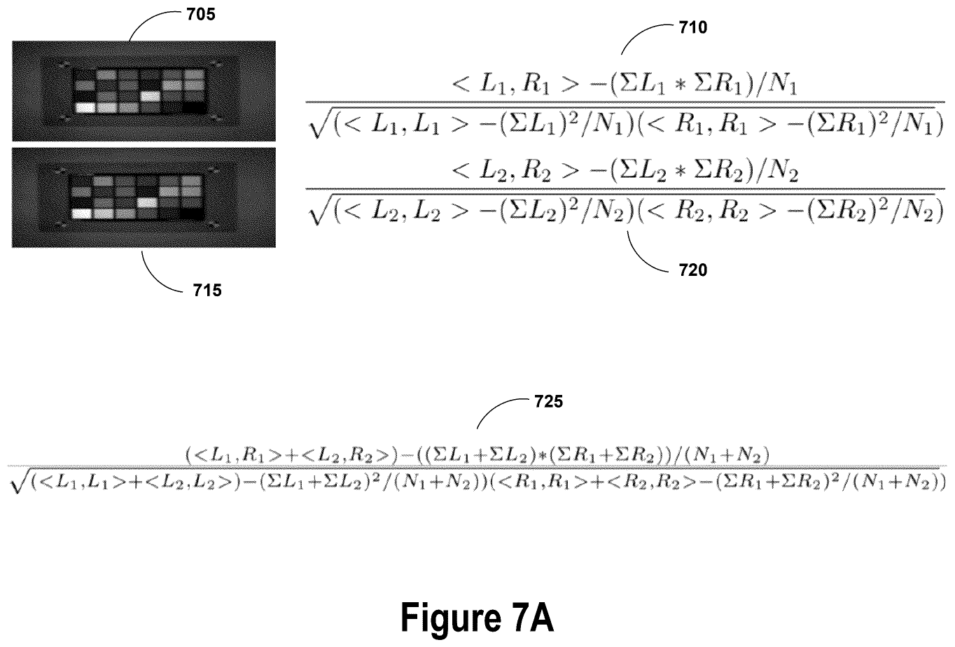

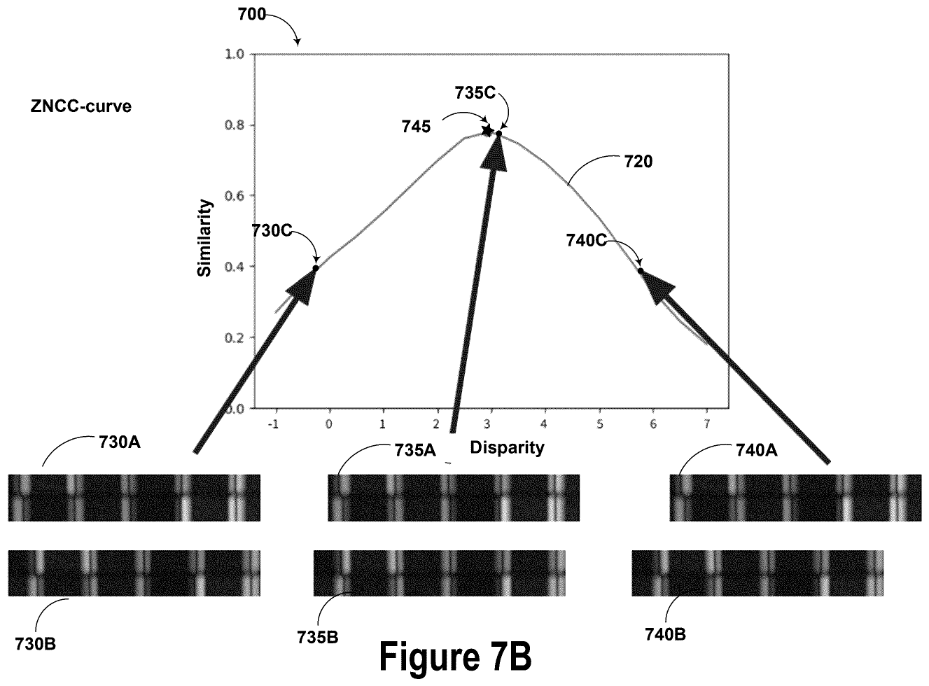

FIG. 7A is an example illustration of determining zero-normalized cross-correlation (ZNCC) values, in accordance with example embodiments. For a given pair of image frames, L and R, image 705 corresponds to a comparison of a first image subblock L₁ of L and a first image subblock R₁ of R. The cross-correlation values may be determined by first relation 710, where N₁ denotes the number of pixels. Image 715 corresponds to a comparison of a second image subblock L₂ of L and a second image subblock R₂ of R. The cross-correlation values may be determined by second relation 720, where N₂ denotes the number of pixels. The values obtained from first relation 710 and second relation 720 may be added as illustrated by third relation 725. These sums may be computed for pairwise image blocks to determine a ZNCC curve. A peak of the ZNCC curve indicates a high degree of similarity.

FIG. 7B is an example graphical illustration 700 of a zero-normalized cross-correlation (ZNCC) curve, in accordance with example embodiments. Similarity values are indicated along a vertical axis and disparity values are indicated along a horizontal axis. For a given pair of image frames, L and R pairwise image blocks may be used to determine a ZNCC curve, as described with reference to FIG. 7A. For example, a first block 730A and a second block 730B may be compared to obtain a first value (indicated on ZNCC curve 720 by first point 730C) based on third relation 725 of FIG. 7A. As another example, a third block 735A and a fourth block 735B may be compared to obtain a second value (indicated on ZNCC curve 720 by second point 735C) based on third relation 725 of FIG. 7A. Also, for example, a fifth block 740A and a sixth block 740B may be compared to obtain a third value (indicated on ZNCC curve 720 by third point 740C) based on third relation 725 of FIG. 7A. Such pairwise blocks may be compared to generate ZNCC curve 720, where a peak point 745 indicates a high degree of similarity. In some embodiments, a disparity value corresponding to peak point 745 may be used to determine defocus. Generally, other considerations may be used to predict the disparity value. For example, a position proximate to the peak point 745 may be used to predict the disparity value.

Additional and/or alternative similarity measures may be used, such as, for example, a sum of absolute differences (SAD), sum of squared differences (SSD), and cross-correlation. Such measures have a formulation that has the stacking property, and may be used in a PDAF-pipeline.

For example, a sum of squared differences may be determined as:

$$SSD ( {Img}_{1} , {Img}_{2} , {u}_{1} , {v}_{1} , {u}_{2} , {v}_{2} n ) = {\sum }_{i = - n j}^{n} {\sum }_{= - n}^{n} {( {Img}_{1} ( {u}_{1} + i , {v}_{1} + j ) - {Img}_{2} ( {u}_{2} + i , {v}_{2} + j ) )}^{2} \qquad ( Eqn . 2 )$$

For two identical images, the sum of squared differences is zero. A value close to zero indicates that the images are highly similar.

In some embodiments, the determining of the aggregated similarity measure includes aggregating constituent terms for a sum of absolute differences (SAD) of the image frames in a set of PD image frames. A sum of absolute differences (SAD) measures similarity between image blocks. An absolute difference is determined between each pixel in a block in the first image and in a corresponding block in the second image. The differences may be summed up to generate a block similarity. The SAD may be determined as:

$$SAD ( {Img}_{1} , {Img}_{2} , {u}_{1} , {v}_{1} , {u}_{2} , {v}_{2} n ) = {\sum }_{i = - n j}^{n} {\sum }_{= - n}^{n} \vert {Img}_{1} ( {u}_{1} + i , {v}_{1} + j ) - {Img}_{2} ( {u}_{2} + i , {v}_{2} + j ) \vert \qquad ( Eqn . 3 )$$

In some embodiments, the determining of the aggregated similarity measure includes aggregating constituent terms for a median of absolute differences (MAD) of the image frames in a set of PD image frames. A median of absolute differences (MAD) also measures similarity between image blocks. An absolute difference is determined between each pixel in a block in the first image and in a corresponding block in the second image. A median of the differences may be determined to generate a similarity measure. The MAD may be determined as:

$$MAD ( {Img}_{1} , {Img}_{2} , {u}_{1} , {v}_{I} , {u}_{2} , {v}_{2} n ) = {\sum }_{i = - n j}^{n} {\sum }_{= - n}^{n} median ( {Img}_{1} ( {u}_{1} + i , {v}_{1} + j ) - {Img}_{2} ( {u}_{2} + i , {v}_{2} + j ) ) \qquad ( Eqn . 4 )$$

In some embodiments, the determining of the aggregated similarity measure is performed temporally. For example, the aggregated similarity measure is based on a plurality of sets of PD image frames captured over time. In some embodiments, the determining of the aggregated similarity measure is performed spatio-temporally. For example, the aggregated similarity measure is based on a plurality of sets of PD image frames captured over time and additionally based on depth information in the plurality of sets of PD images. Also, for example, the ROI may be made temporally larger (e.g., to improve the signal).

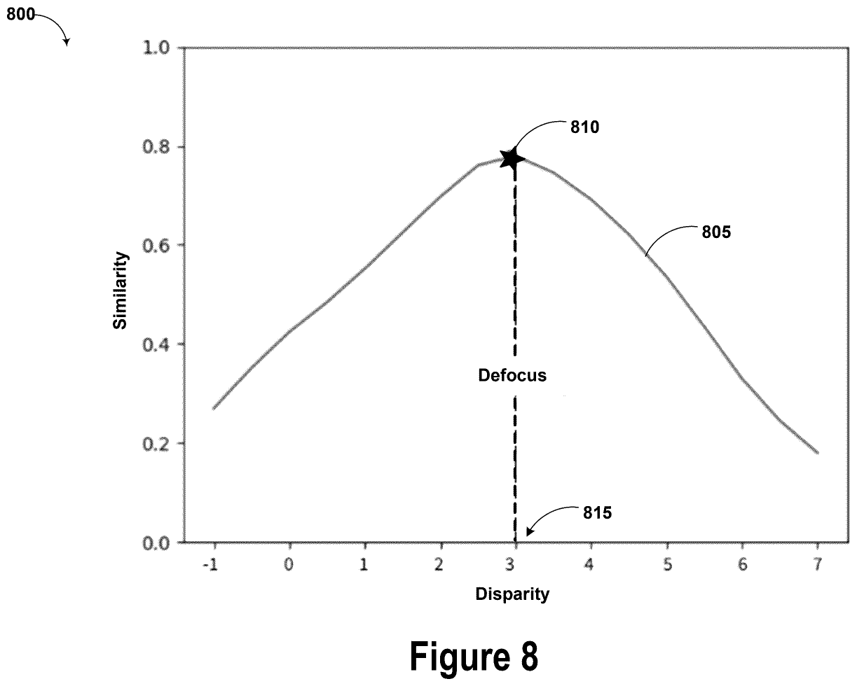

FIG. 8 is an example graphical illustration 800 of determining disparity in the PDAF pipeline, in accordance with example embodiments. Similarity values are indicated along a vertical axis and disparity values are indicated along a horizontal axis. An aggregated similarity curve 805 is displayed with a peak point 810. A disparity value 815 corresponding to peak point 810 may be identified and used for defocus.

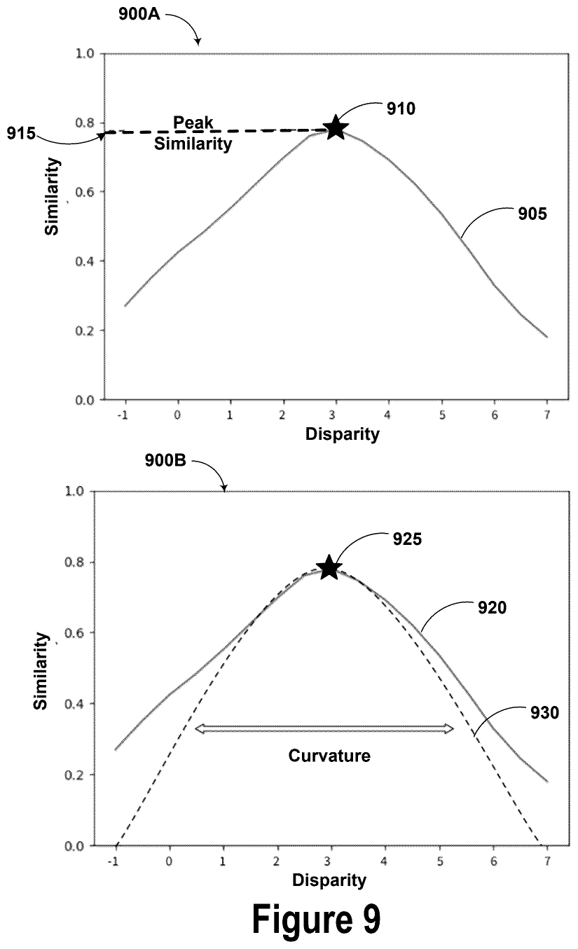

FIG. 9 illustrates determination of peak similarity and curvature in the PDAF pipeline, in accordance with example embodiments. Some embodiments involve determining, based on the aggregated similarity measure, a peak similarity value. In graphical illustration 900A, similarity values are indicated along a vertical axis and disparity values are indicated along a horizontal axis. An aggregated similarity curve 905 is displayed with a peak point 910. A similarity value 915 corresponding to peak point 910 may be identified.

Some embodiments involve determining a curvature for the aggregated similarity measure. In graphical illustration 900B, similarity values are indicated along a vertical axis and disparity values are indicated along a horizontal axis. An aggregated similarity curve 920 is displayed with a peak point 925. An approximation curve 930 (e.g., a quadratic approximation) constrained to pass through peak point 925 may be used to approximate aggregated similarity curve 920. The approximation curve 930 may be used to determine a curvature value.

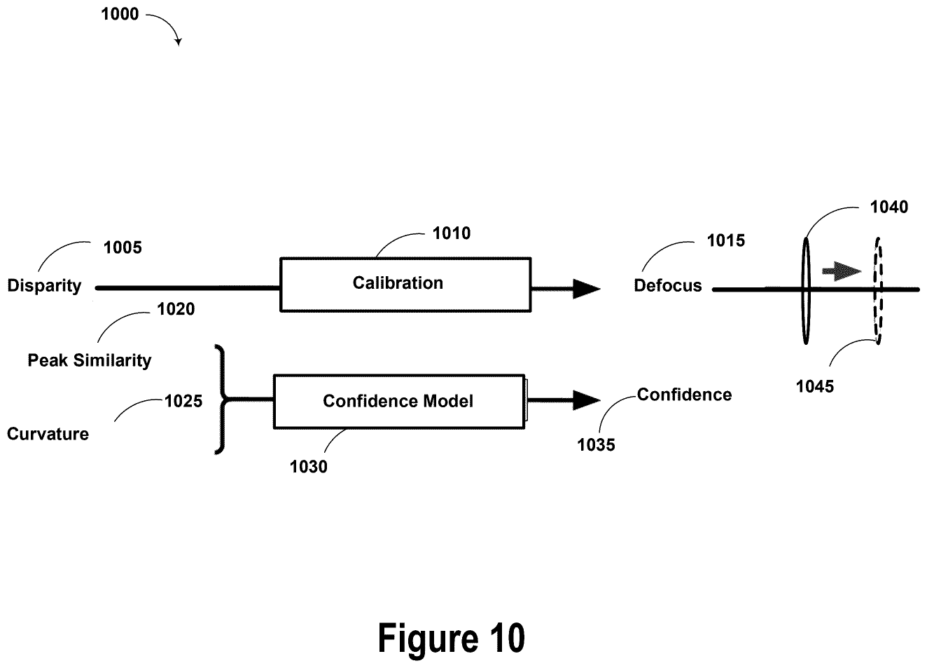

FIG. 10 is an example illustration of camera calibration 1000 in the PDAF pipeline, in accordance with example embodiments. A disparity value 1005 may be determined, as described with reference to FIG. 8. A camera calibration 1010 may be performed based on the disparity value 1005, and a defocus adjustment 1015 may be determined. Defocus adjustment 1015 adjusts the camera lens from an initial position 1040 to a target position 1045.

In some embodiments, a peak similarity 1020 and a curvature value 1025 may be determined, as described with reference to FIG. 9. These values may be provided to a confidence model 1030 to generate a confidence level 1035. Some embodiments involve determining whether the peak similarity value exceeds a peak threshold. Such embodiments also involve, upon a determination that the peak similarity value exceeds the peak threshold, associating the predicted focus disparity with a high confidence level. For example, confidence model 1030 may determine whether the peak similarity 1020 exceeds a peak threshold. Upon a determination that the peak similarity 1020 exceeds the peak threshold, confidence model 1030 may associate the predicted focus disparity 1005 with a confidence level 1035 indicative of high confidence. Upon a determination that the peak similarity 1020 does not exceed the peak threshold, confidence model 1030 may associate the predicted focus disparity 1005 with a confidence level 1035 indicative of low confidence.

Some embodiments involve determining whether the curvature is within a curvature threshold. Such embodiments also involve, upon a determination that the curvature is within the curvature threshold, associating the predicted focus disparity with a high confidence level. For example, confidence model 1030 may determine whether the curvature value 1025 is within a curvature threshold. Upon a determination that the curvature value 1025 is within the curvature threshold, confidence model 1030 may associate the predicted focus disparity 1005 with a confidence level 1035 indicative of high confidence. Upon a determination that the curvature value 1025 is not within the curvature threshold, confidence model 1030 may associate the predicted focus disparity 1005 with a confidence level 1035 indicative of low confidence.

Generally speaking, camera calibration 1000 may perform defocus adjustment 1015 based on confidence level 1035. The camera lens may be adjusted from the initial position 1040 to the target position 1045 in the event that confidence level 1035 is indicative of high confidence. The camera lens may not be adjusted from the initial position 1040 to the target position 1045 in the event that confidence level 1035 is indicative of low confidence.

For example, when there is movement from one image frame to another (e.g., a horse moving), in the event the horse is at a substantially same depth in successive frames, the confidence level 1035 is likely to indicate high confidence. In the event the movement occurs where the ROI (e.g., horse) appears at different depths, the confidence level 1035 is likely to indicate low confidence.

Also, for example, the aggregated similarity measure is generally associated with a confidence level that tracks frames that have a higher confidence level. Accordingly, with changes in depth, the resultant confidence level tracks frames with more stable depth variations.

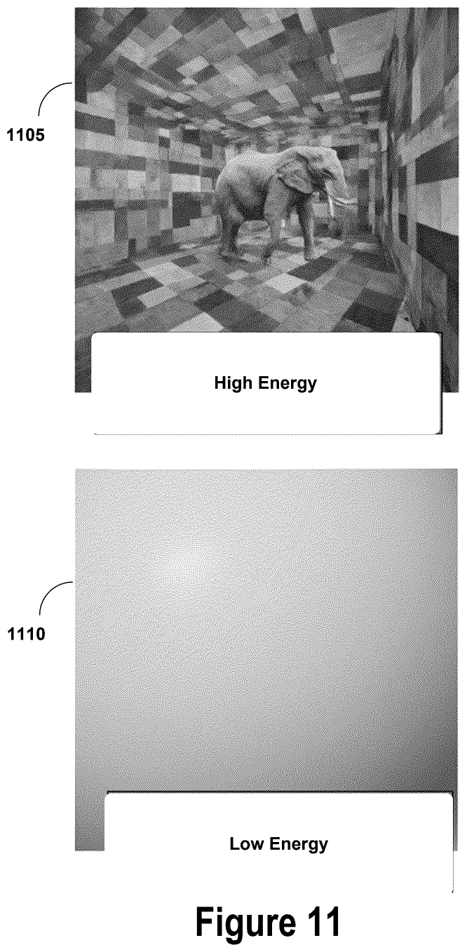

FIG. 11 illustrates a high energy image and a low energy image, in accordance with example embodiments. For example, image 1105 has several colors and multiple edges. Accordingly, image 1105 may be associated with a high energy. A high energy image provides multiple feature points to aid in focusing a camera lens. Image 1110 is a grayscale image with no features. Accordingly, image 1110 may be associated with a low energy level.

In some embodiments, similarity curves may be averaged and/or weighted by energy. For example, a higher weight may be associated with an image of high energy, and a lower weight may be associated with an image of low energy. In such embodiments, the adjusting of the lens position based on the predicted focus disparity may correspond to determining an aggregated similarity measure by aggregating respective weighted similarity measures. For example, frames that have higher energy may be weighted to contribute more to the aggregated similarity measure. In some embodiments, similarity curves may be averaged and/or weighted by other factors such as confidence levels, motion statistics, and so forth.

In some embodiments, the adjusting of the lens position based on the predicted focus disparity may correspond to post-processing an image by gluing ROIs into a larger ROI, without a resultant motion blur. In such embodiments, the adjusting of the lens position causes the camera to capture an image frame that simulates a stacking of a plurality of image frames comprising a plurality of respective depths, without a resultant motion blur.

Additional and/or alternative factors may determine when to trigger a determination of an aggregated similarity measure. For example, determination of an aggregated similarity measure may be triggered when the ambient light for the scene is below a threshold brightness. Also, for example, determination of an aggregated similarity measure may not be triggered when the ROI changes (e.g., switches from a face to another face or an object). Switching of ROIs would likely result in the camera being focused on a different object.

As described herein, temporal stacking enables fast, accurate, and stable autofocus in low-light environments, even under extreme conditions. It has the capacity to stabilize lens movements under different light conditions. By summing information from multiple image frames captured over a short time interval, the techniques described herein effectively increase the signal-to-noise ratio and improve autofocus performance without the drawbacks of long exposure times and with low computational overhead.

### Computing Device Architecture

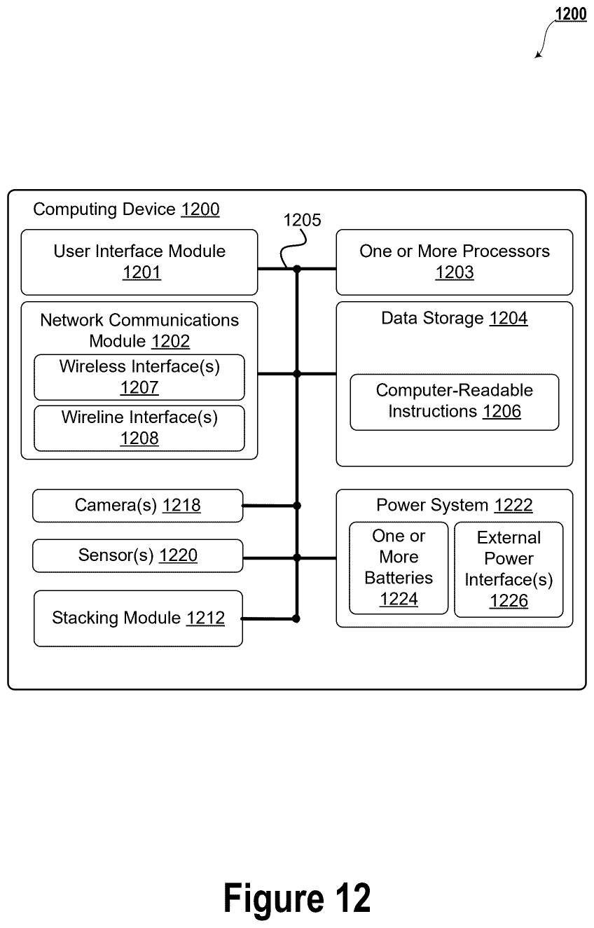

FIG. 12 is a block diagram of an example computing device 1200, in accordance with example embodiments. In particular, computing device 1200 shown in FIG. 12 can be configured to perform at least one function described herein, including method 1300.

Computing device 1200 may include a user interface module 1201, a network communications module 1202, one or more processors 1203, data storage 1204, one or more cameras 1218, one or more sensors 1220, and power system 1222, all of which may be linked together via a system bus, network, or other connection mechanism 1205.

User interface module 1201 can be operable to send data to and/or receive data from external user input/output devices. For example, user interface module 1201 can be configured to send and/or receive data to and/or from user input devices such as a touch screen, a computer mouse, a keyboard, a keypad, a touch pad, a trackball, a joystick, a voice recognition module, and/or other similar devices. User interface module 1201 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, cither now known or later developed. User interface module 1201 can also be configured to generate audible outputs, with devices such as a speaker, speaker jack, audio output port, audio output device, earphones, and/or other similar devices. User interface module 1201 can further be configured with one or more haptic devices that can generate haptic outputs, such as vibrations and/or other outputs detectable by touch and/or physical contact with computing device 1200. In some examples, user interface module 1201 can be used to provide a graphical user interface (GUI) for utilizing computing device 1200.

Network communications module 1202 can include one or more devices that provide one or more wireless interfaces 1207 and/or one or more wireline interfaces 1208 that are configurable to communicate via a network. Wireless interface(s) 1207 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 1208 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 1202 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 1203 can include one or more general purpose processors (e.g., central processing unit (CPU), etc.), and/or one or more special purpose processors (e.g., digital signal processors, tensor processing units (TPUs), graphics processing units (GPUs), application specific integrated circuits, etc.). One or more processors 1203 can be configured to execute computer-readable instructions 1206 that are contained in data storage 1204 and/or other instructions as described herein.

Data storage 1204 can include one or more non-transitory computer-readable storage media that can be read and/or accessed by at least one of one or more processors 1203. The one or more computer-readable storage media can include volatile and/or non-volatile storage components, such as optical, magnetic, organic or other memory or disc storage, which can be integrated in whole or in part with at least one of one or more processors 1203. In some examples, data storage 1204 can be implemented using a single physical device (e.g., one optical, magnetic, organic or other memory or disc storage unit), while in other examples, data storage 1204 can be implemented using two or more physical devices.

Data storage 1204 can include computer-readable instructions 1206 and perhaps additional data. In some examples, data storage 1204 can include storage required to perform at least part of the herein-described methods, scenarios, and techniques and/or at least part of the functionality of the herein-described devices and networks. In particular, computer-readable instructions 1206 can include instructions that, when executed by processor(s) 1203, enable computing device 1200 to provide for some or all of the functionality described herein.

In some embodiments, computer-readable instructions 1206 can include instructions that, when executed by processor(s) 1203, enable computing device 1200 to carry out operations. The operations may include receiving a plurality of successive sets of phase-detection (PD) image frames. The operations may also include determining, for each set of the plurality of successive sets, a respective similarity measure indicative of a respective frame disparity in the PD image frames. The operations may additionally include determining an aggregated similarity measure by aggregating respective similarity measures corresponding to the plurality of successive sets. The operations may further include predicting, based on the aggregated similarity measure, a focus disparity for phase-detection autofocus (PDAF). The operations may also include providing, based on the predicted focus disparity, an adjustment to a lens position for a camera.

In some embodiments, the operations for the determining of the aggregated similarity measure involve operations for aggregating constituent terms for a sum of absolute differences (SAD) of the image frames in a set of PD image frames.

In some embodiments, the operations for the determining of the aggregated similarity measure involve operations for aggregating constituent terms for a sum of squared differences (SSD) of the image frames in a set of PD image frames.

In some embodiments, the operations for the determining of the aggregated similarity measure involve operations for aggregating constituent terms for a median of absolute differences (MAD) of the image frames in a set of PD image frames.

In some embodiments, the operations for the determining of the aggregated similarity measure involve operations for aggregating constituent terms for a zero-normalized cross-correlation (ZNCC) of the image frames in a set of PD image frames. In some embodiments, the operations for the determining of the aggregated similarity measure involve operations for aggregating constituent terms for a normalized cross-correlation (NCC) of the image frames in a set of PD image frames

In some embodiments, the operations involve determining, based on the aggregated similarity measure, a peak similarity value. The operations also involve determining whether the peak similarity value exceeds a peak threshold. The operations further involve, upon a determination that the peak similarity value exceeds the peak threshold, associating the predicted focus disparity with a high confidence level.

In some embodiments, the operations involve determining a curvature for the aggregated similarity measure. The operations also involve determining a curvature for the aggregated similarity measure. The operations further involve, upon a determination that the curvature is within the curvature threshold, associating the predicted focus disparity with a high confidence level.

In some embodiments, an ambient light for the scene is below a threshold brightness.

In some embodiments, the operations for the determining of the aggregated similarity measure involve operations for determining the aggregated similarity measure temporally.

In some embodiments, the operations for the determining of the aggregated similarity measure involve operations for determining the aggregated similarity measure spatio-temporally.

Some embodiments involve adjusting the lens position for the camera based on the predicted focus disparity.

In some examples, computing device 1200 can include stacking module 1212. Stacking module 1212 can be configured to determining an aggregated similarity measure and predict a focus disparity for phase-detection autofocus (PDAF). Also, for example, stacking module 1212 can be configured to determine when to trigger the determining of the aggregated similarity measure.

In some examples, computing device 1200 can include one or more cameras 1218. Camera(s) 1218 can include one or more image capture devices, such as still and/or video cameras, equipped to capture light and record the captured light in one or more images; that is, camera(s) 1218 can generate image(s) of captured light. The one or more images can be one or more still images and/or one or more images utilized in video imagery. Camera(s) 1218 can capture light and/or electromagnetic radiation emitted as visible light, infrared radiation, ultraviolet light, and/or as one or more other frequencies of light. Camera(s) 1218 can include a wide camera, a tele camera, an ultrawide camera, and so forth. Also, for example, camera(s) 1218 can be front-facing or rear-facing cameras with reference to computing device 1200. Camera(s) 1218 can include camera components such as, but are not limited to, an aperture, shutter, recording surface (e.g., photographic film and/or an image sensor), lens, and/or shutter button. The camera components may be controlled at least in part by software executed by one or more processors 1203.

In some examples, computing device 1200 can include one or more sensors 1220. Sensors 1220 can be configured to measure conditions within computing device 1200 and/or conditions in an environment of computing device 1200 and provide data about these conditions. For example, sensors 1220 can include one or more of: (i) sensors for obtaining data about computing device 1200, such as, but not limited to, a thermometer for measuring a temperature of computing device 1200, a battery sensor for measuring power of one or more batteries of power system 1222, and/or other sensors measuring conditions of computing device 1200; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 1200, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 1200, such as, but not limited to, an infrared sensor, an optical sensor, a light sensor (e.g., an ambient light sensor), a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 1200, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 1220 are possible as well.

Power system 1222 can include one or more batteries 1224 and/or one or more external power interfaces 1226 for providing electrical power to computing device 1200. Each battery of the one or more batteries 1224 can, when electrically coupled to the computing device 1200, act as a source of stored electrical power for computing device 1200. One or more batteries 1224 of power system 1222 can be configured to be portable. Some or all of one or more batteries 1224 can be readily removable from computing device 1200. In other examples, some or all of one or more batteries 1224 can be internal to computing device 1200, and so may not be readily removable from computing device 1200. Some or all of one or more batteries 1224 can be rechargeable. For example, a rechargeable battery can be recharged via a wired connection between the battery and another power supply, such as by one or more power supplies that are external to computing device 1200 and connected to computing device 1200 via the one or more external power interfaces. In other examples, some or all of one or more batteries 1224 can be non-rechargeable batteries.

One or more external power interfaces 1226 of power system 1222 can include one or more wired-power interfaces, such as a USB cable and/or a power cord, that enable wired electrical power connections to one or more power supplies that are external to computing device 1200. One or more external power interfaces 1226 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1226, computing device 1200 can draw electrical power from the external power source the established electrical power connection. In some examples, power system 1222 can include related sensors, such as battery sensors associated with the one or more batteries or other types of electrical power sensors.

One or more external power interfaces 1226 of power system 1222 can include one or more wired-power interfaces, such as a USB cable and/or a power cord, that enable wired electrical power connections to one or more power supplies that are external to computing device 1200. One or more external power interfaces 1226 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1226, computing device 1200 can draw electrical power from the external power source the established electrical power connection. In some examples, power system 1222 can include related sensors, such as battery sensors associated with the one or more batteries or other types of electrical power sensors.

### Example Methods of Operation

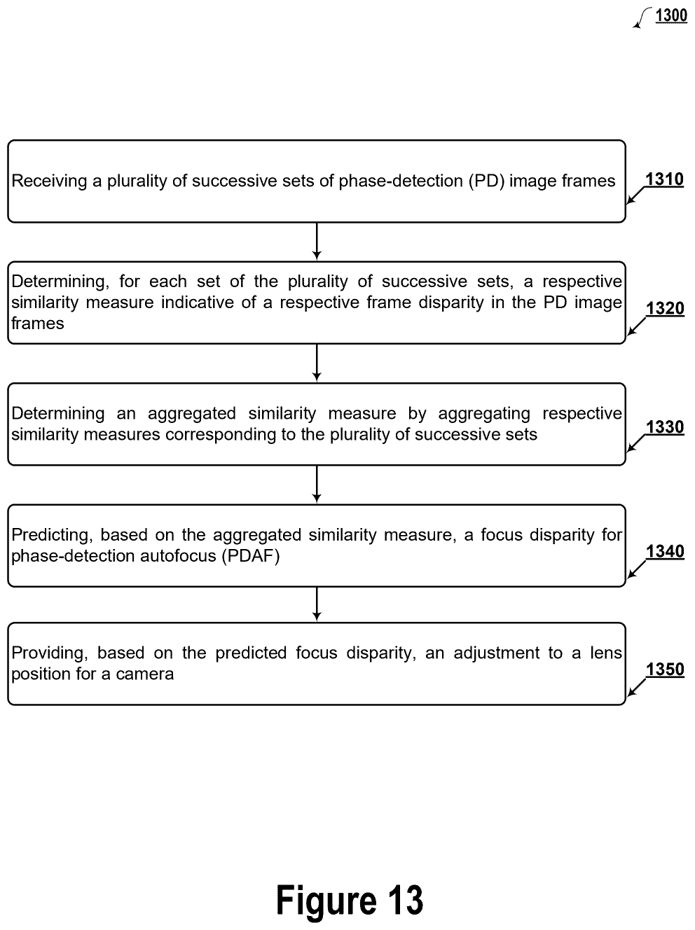

FIG. 13 is a flowchart of a method, in accordance with example embodiments. Method 1300 may include various blocks or steps. The blocks or steps may be carried out individually or in combination. The blocks or steps may be carried out in any order and/or in series or in parallel. Further, blocks or steps may be omitted or added to method 1300.

The blocks of method 1300 may be carried out by various elements of computing device 1200 as illustrated and described in reference to FIG. 12.

Block 1310 involves receiving a plurality of successive sets of phase-detection (PD) image frames.

Block 1320 involves determining, for each set of the plurality of successive sets, a respective similarity measure indicative of a respective frame disparity in the PD image frames.

Block 1330 involves determining an aggregated similarity measure by aggregating respective similarity measures corresponding to the plurality of successive sets.

Block 1340 involves predicting, based on the aggregated similarity measure, a focus disparity for phase-detection autofocus (PDAF).

Block 1340 involves providing, based on the predicted focus disparity, an adjustment to a lens position for a camera.

In some embodiments, the determining of the aggregated similarity measure includes aggregating constituent terms for a sum of absolute differences (SAD) of the image frames in a set of PD image frames.

In some embodiments, the determining of the aggregated similarity measure includes aggregating constituent terms for a median of absolute differences (MAD) of the image frames in a set of PD image frames.

In some embodiments, the determining of the aggregated similarity measure includes aggregating constituent terms for a zero-normalized cross-correlation (ZNCC) of the image frames in a set of PD image frames.

Some embodiments involve determining, based on the aggregated similarity measure, a peak similarity value. Such embodiments involve determining whether the peak similarity value exceeds a peak threshold. Such embodiments also involve, upon a determination that the peak similarity value exceeds the peak threshold, associating the predicted focus disparity with a high confidence level.

Some embodiments involve determining a curvature for the aggregated similarity measure. Such embodiments involve determining whether the curvature is within a curvature threshold. Such embodiments also involve, upon a determination that the curvature is within the curvature threshold, associating the predicted focus disparity with a high confidence level.

In some embodiments, an ambient light for the scene is below a threshold brightness.

In some embodiments, the determining of the aggregated similarity measure is performed temporally.

In some embodiments, the determining of the aggregated similarity measure is performed spatio-temporally.

Some embodiments involve adjusting the lens position for the camera based on the predicted focus disparity.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods. Thus, the computer readable media may include secondary or persistent long-term storage, like read only memory (ROM), optical or magnetic disks, compact disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A computer-implemented method, comprising:
receiving a plurality of successive sets of phase-detection (PD) image frames;
determining, for each set of the plurality of successive sets, a respective similarity measure indicative of a respective frame disparity in the PD image frames;
determining an aggregated similarity measure by aggregating respective similarity measures corresponding to the plurality of successive sets;
predicting, based on the aggregated similarity measure, a focus disparity for phase-detection autofocus (PDAF); and
providing, based on the predicted focus disparity, an adjustment to a lens position for a camera.

2. The computer-implemented method of claim 1, wherein the determining of the aggregated similarity measure comprises aggregating constituent terms for a sum of absolute differences (SAD) of the image frames in a set of PD image frames.

3. The computer-implemented method of claim 1, wherein the determining of the aggregated similarity measure comprises aggregating constituent terms for a median of absolute differences (MAD) of the image frames in a set of PD image frames.

4. The computer-implemented method of claim 1, wherein the determining of the aggregated similarity measure comprises aggregating constituent terms for a zero-normalized cross-correlation (ZNCC) of the image frames in a set of PD image frames.

5. The computer-implemented method of claim 1, further comprising:
determining, based on the aggregated similarity measure, a peak similarity value;
determining whether the peak similarity value exceeds a peak threshold; and
upon a determination that the peak similarity value exceeds the peak threshold, associating the predicted focus disparity with a high confidence level.

6. The computer-implemented method of claim 1, further comprising:
determining a curvature for the aggregated similarity measure;
determining whether the curvature is within a curvature threshold; and
upon a determination that the curvature is within the curvature threshold, associating the predicted focus disparity with a high confidence level.

7. The computer-implemented method of claim 1, wherein an ambient light for the scene is below a threshold brightness.

8. The computer-implemented method of claim 1, wherein the determining of the aggregated similarity measure is performed temporally.

9. The computer-implemented method of claim 1, wherein the determining of the aggregated similarity measure is performed spatio-temporally.

10. The computer-implemented method of claim 1, further comprising:
adjusting the lens position for the camera based on the predicted focus disparity.

11. A computing device, comprising:
one or more processors; and
data storage, wherein the data storage has stored thereon computer-executable instructions that, when executed by the one or more processors, cause the computing device to carry out operations comprising:
receiving a plurality of successive sets of phase-detection (PD) image frames;
determining, for each set of the plurality of successive sets, a respective similarity measure indicative of a respective frame disparity in the PD image frames;
determining an aggregated similarity measure by aggregating respective similarity measures corresponding to the plurality of successive sets;
predicting, based on the aggregated similarity measure, a focus disparity for phase-detection autofocus (PDAF); and
providing, based on the predicted focus disparity, an adjustment to a lens position for a camera.

12. The computing device of claim 11, wherein the operations for the determining of the aggregated similarity measure comprise operations for aggregating constituent terms for a sum of absolute differences (SAD) of the image frames in a set of PD image frames.

13. The computing device of claim 11, wherein the operations for the determining of the aggregated similarity measure comprise operations for aggregating constituent terms for a median of absolute differences (MAD) of the image frames in a set of PD image frames.

14. The computing device of claim 11, wherein the operations for the determining of the aggregated similarity measure comprise operations for aggregating constituent terms for a zero-normalized cross-correlation (ZNCC) of the image frames in a set of PD image frames.

15. The computing device of claim 11, the operations further comprising:
determining, based on the aggregated similarity measure, a peak similarity value;
determining whether the peak similarity value is exceeds a peak threshold; and
upon a determination that the peak similarity value exceeds the peak threshold, associating the predicted focus disparity with a high confidence level.

16. The computing device of claim 11, the operations further comprising:
determining a curvature for the aggregated similarity measure;
determining a curvature for the aggregated similarity measure; and
upon a determination that the curvature is within the curvature threshold, associating the predicted focus disparity with a high confidence level.

17. The computing device of claim 11, wherein an ambient light for the scene is below a threshold brightness.

18. The computing device of claim 11, wherein the operations for the determining of the aggregated similarity measure comprise operations for determining the aggregated similarity measure temporally.

19. The computing device of claim 11, wherein the operations for the determining of the aggregated similarity measure comprise operations for determining the aggregated similarity measure spatio-temporally.

20. The computing device of claim 11, the operations further comprising:
adjusting the lens position for the camera based on the predicted focus disparity.

21. An article of manufacture comprising one or more non-transitory computer readable media having computer-readable instructions stored thereon that, when executed by one or more processors of a computing device, cause the computing device to carry out functions comprising:
receiving a plurality of successive sets of phase-detection (PD) image frames;
determining, for each set of the plurality of successive sets, a respective similarity measure indicative of a respective frame disparity in the PD image frames;
determining an aggregated similarity measure by aggregating respective similarity measures corresponding to the plurality of successive sets;
predicting, based on the aggregated similarity measure, a focus disparity for phase-detection autofocus (PDAF); and
providing, based on the predicted focus disparity, an adjustment to a lens position for a camera.
